(19) United States
(12) Patent Application Publication
(10) Pub. No.: US 2016/0049858 A1
(43) Pub. Date: Feb. 18, 2016

(54) LC RESONANT CONVERTER USING PHASE SHIFT SWITCHING METHOD

(71) Applicants: Hyundai Motor Company, Seoul (KR); Kia Motors Corporation, Seoul (KR); Myongji University Industry and Academia Cooperation Foundation, Yongin (KR)

(72) Inventors: Jong Pil Kim, Yongin (KR); Woo Young Lee, Chungcheongbuk-do (KR); Hyun Wook Seong, Hwaseong (KR); Seung Woo Ha, Suwon (KR); June Young Lee, Yongin (KR)

(21) Appl. No.: 14/569,748

(22) Filed: Dec. 14, 2014

(30) Foreign Application Priority Data
Aug. 13, 2014 (KR) 10-2014-0105313

(51) Int. Cl. H02M 1/00; H02M 3/335

(52) U.S. Cl. CPC H02M 1/00; H02M 3/33523; H02M 2001/0003

(57) ABSTRACT

A LC resonant converter using a phase shift switching method includes: a switching unit configured to receive a switching signal according to a phase shift control and to perform zero voltage switching (ZVS) in a leading leg circuit and a lagging leg circuit when a light load is present; a transformer configured to output an output voltage of the switching unit as a predetermined level of voltage; a resonance circuit unit configured to convert frequency characteristics of an alternating voltage transferred from the transformer; and a bridge rectifying circuit unit configured to rectify the alternating voltage whose frequency characteristics are converted into a direct voltage.

### CROSS-REFERENCE TO RELATED APPLICATION

This application claims the benefit of and priority to Korean Patent Application No. 10-2014-0105313, filed on Aug. 13, 2014 in the Korean Intellectual Property Office, the disclosure of which is incorporated herein in its entirety by reference.

### TECHNICAL FIELD

The present disclosure relates to an inductor-capacitor (LC) resonant converter, and more particularly, to an LC resonant converter capable of limiting a current by resonance while facilitating zero voltage switching using a phase shift switching method.

### BACKGROUND

An energy storage system or an energy storage apparatus stores power using a battery and supplies the power to a load. As the battery, a Li-ion battery is often used and is generally charged by a constant current/constant voltage charging method. The constant current/constant voltage charging method uses a constant voltage charging method which sets a predetermined current in a constant current operation section to begin charging, stops a constant current operation when a voltage of the battery is increased according to the charging of the battery, and thus the increased voltage reaches a predetermined saturation voltage set in the battery, and controls the voltage of the battery.

The typical energy storage apparatus includes a power conversion apparatus using zero voltage switching (ZVS) and zero current switching (ZCS), which are soft switching techniques using resonant characteristics so as to reduce an electromagnetic interference (EMI) noise stress due to switching. The switching technology may realize fast switching and may realize miniaturization and weight lightening of the power conversion apparatus and increased efficiency of the power conversion apparatus.

A resonant converter generally includes a transformer, an inductor, and a capacitor element, which are designed to be resonated, and the resonant converter is operated by the zero voltage switching or the zero current switching to implement the soft switching. To this point, efforts have been set forth to minimize a switching loss by removing a section in which a voltage and a current are simultaneously present from an on-off transient section of a switching element.

### SUMMARY

The present disclosure has been made to solve the above-mentioned problems occurring in the related art while advantages achieved by the related art are maintained intact.

An aspect of the present disclosure provides an LC resonant converter using a phase shift switching method capable of facilitating zero voltage switching and limiting a current by resonance using a resonance circuit whose secondary current side is provided with a resonance inductor and a resonance capacitor so as to limit a current without using an output filter (e.g., an output inductor).

According to embodiments of the present disclosure, an LC resonant converter using a phase shift switching method includes: a switching unit configured to receive a switching signal according to a phase shift control and to perform zero voltage switching (ZVS) in a leading leg circuit and a lagging leg circuit when a light load is present; a transformer configured to output an output voltage of the switching unit as a predetermined level of voltage; a resonance circuit unit configured to convert frequency characteristics of an alternating voltage transferred from the transformer; and a bridge rectifying circuit unit configured to rectify an alternating voltage whose frequency characteristics are converted into a direct voltage.

The switching unit may include a leading leg circuit LE and a lagging leg circuit LA, each being configured of two switches and the leading leg circuit LE and the lagging leg circuit LA may have a duty ratio of 50% and may be complementarily operated.

The leading leg circuit LE may be configured of two switches M1 and M2, the lagging leg circuit LA may be configured of two switches M3 and M4, each of the switches M1, M2, M3, and M4 may be connected to anti-parallel diodes D1, D2, D3, and D4, respectively, and both ends of each anti-parallel diode may be connected to output capacitors C1, C2, C3, and C4.

A primary side terminal of the transformer may be connected between the two switches M1 and M2 of the leading leg circuit LE and between the two switches M3 and M4 of the lagging leg circuit LA.

The resonance circuit unit may be provided at a secondary side of the transformer and be connected to the bridge rectifying circuit unit.

The resonance circuit unit may include a resonance inductor Lr and a resonance capacitor Cr.

The resonance circuit unit may include a resonance inductor Lr and a resonance capacitor Cr which are connected to each other in series.

### BRIEF DESCRIPTION OF THE DRAWINGS

The above and other objects, features and advantages of the present disclosure will be more apparent from the following detailed description taken in conjunction with the accompanying drawings.

FIG. 1 is a circuit diagram illustrating an LC resonant converter using a phase shift switching method according to embodiments of the present disclosure;

FIG. 2 is waveform diagram for each operation mode for describing an operation relationship of the LC resonant converter using a phase shift switching method according to embodiments of the present disclosure; and

FIGS. 3A to 3H are equivalent circuits depending on each of the operation modes of the LC resonant converter using a phase shift switching method according to embodiments of the present disclosure.

### DETAILED DESCRIPTION

The foregoing objects, features and advantages will become more apparent from the following description of embodiments of the present disclosure with reference to accompanying drawings, which are set forth hereinafter. Accordingly, those having ordinary knowledge in the related art to which the present disclosure pertains will easily embody technical ideas or spirit of the present disclosure. Further, when technical configurations known in the related art are considered to make the contents obscure in the present disclosure, the detailed description thereof will be omitted. Hereinafter, embodiments of the present disclosure will be described in detail with reference to the accompanying drawings.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

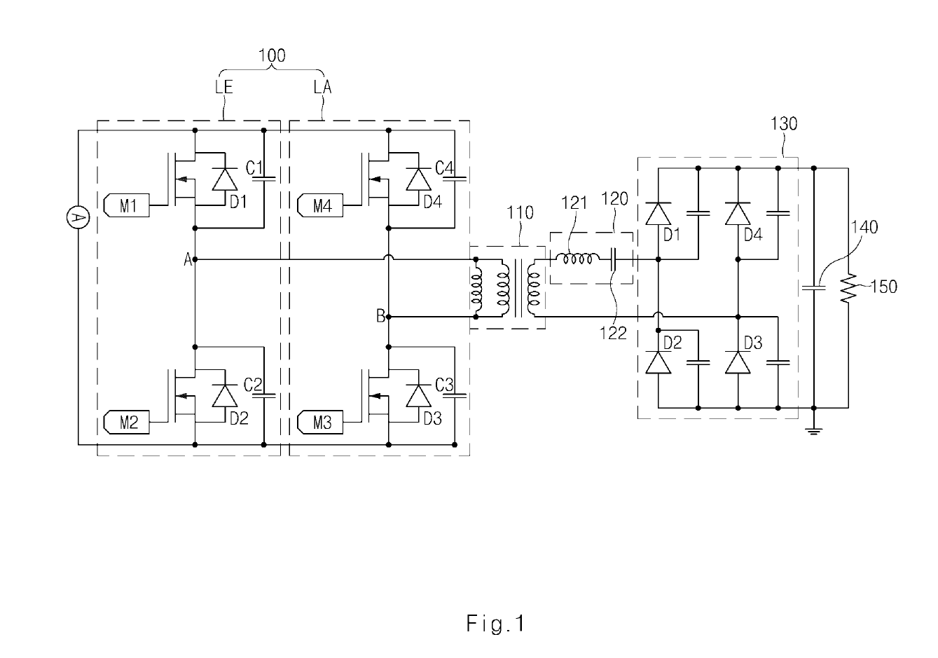

FIG. 1 is a circuit diagram illustrating an LC resonant converter using a phase shift switching method according to embodiments of the present disclosure.

Referring to FIG. 1, the LC resonant converter includes a switching unit 100 configured to receive a switching signal according to a phase shift control and to perform zero voltage switching (ZVS) in a leading leg LE and a lagging leg LA at the time of a light load, a transformer T 110 configured to output an output voltage of the switching unit 100 as a predetermined level of voltage, and a resonance circuit unit 120 configured to convert frequency characteristics of an alternating voltage transferred from the transformer 110, in which the resonant circuit unit 120 includes a resonance inductor Ir 121 and a resonance capacitor Cr 122. Further, the LC resonant converter includes a bridge rectifying circuit unit 130 configured to rectify an alternating voltage whose frequency characteristics are converted into a direct voltage, a capacitor 140 configured to filter the rectified direct voltage, and an output unit 150 configured to output the filtered direct voltage.

The switching unit 100 includes a leading leg circuit LE and a lagging leg circuit LA each configured of two switches, in which the leading leg circuit LE and the lagging leg circuit LA are opposite to each other to have a complementary relationship. Further, the switching unit 100 alternately switches an input voltage to convert the direct voltage into the alternating voltage and transfer the converted alternating voltage to the transformer 110.

Meanwhile, the leading leg circuit LE is configured of two switches M1 and M2, and the lagging leg circuit LA is configured of two switches M3 and M4, in which each switch M1, M2, M3, and M4 is connected to anti-parallel diodes D1, D2, D3, and D4, respectively, and both ends of each of the anti-parallel diodes D1, D2, D3, and D4 are connected to output capacitors C1, C2, C3, and C4. Further, a primary side terminal of the transformer 110 is connected between the two switches M1 and M2 of the leading leg circuit LE and between the two switches M3 and M4 of the lagging leg circuit LA.

In the so configured switching unit 100, the leading leg circuit LE and the lagging leg circuit LA are complementarily operated at a predetermined duty ratio, preferably, a duty ratio of 50%, and an output thereof is determined by a phase shift control between the leading leg circuit LE and the lagging leg circuit LA. The transformer 110 outputs the output voltage of the switching unit 100 as a predetermined level of voltage.

The resonance circuit unit 120 converts the frequency characteristics of the alternating voltage transferred from the transformer 110 and includes the resonance inductor 121 and the resonance capacitor 122. The resonance circuit unit 120 is connected to the diodes D1, D2, D3, and D4 of the bridge rectifying circuit unit 130 which is provided at the secondary side of the transformer 110. In this configuration, the resonance inductor 121 and the resonance capacitor 122 may be connected to each other in a serial form.

In detail, the resonance circuit unit 120 is provided at the secondary side of the transformer 110, such that the LC resonant converter may keep a magnetizing current by magnetizing inductance Lm and implement zero voltage switching without being affected by an effective duty. It is possible to reduce a voltage stress of an element provided at the secondary side of the transformer 110 by limiting the output current by resonance without an output inductor.

The bridge rectifying circuit unit 130 rectifies the alternating voltage whose frequency characteristics are converted into the direct voltage. Next, the rectified direct voltage is filtered by the capacitor 140 and the output voltage is output through the output unit 150.

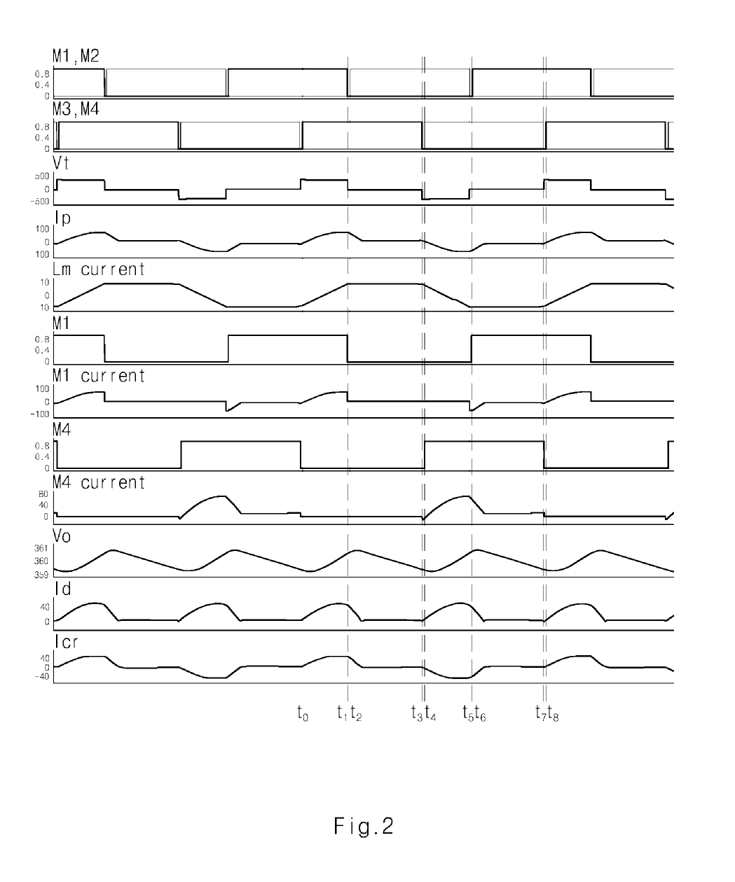

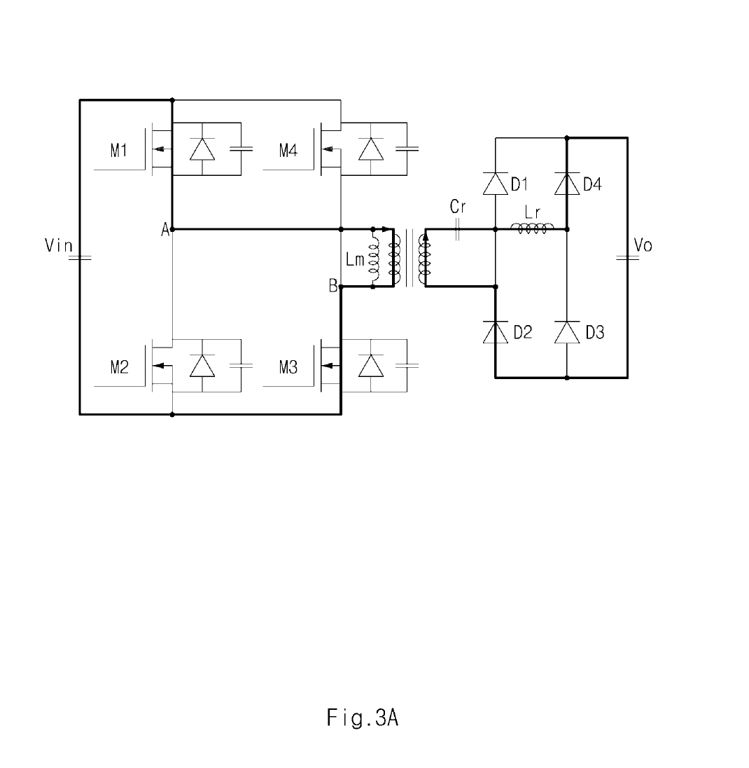

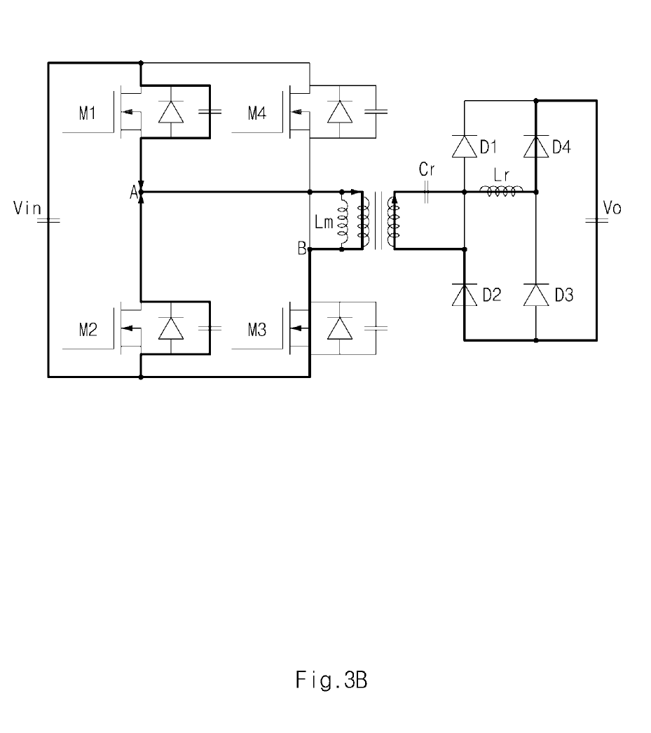

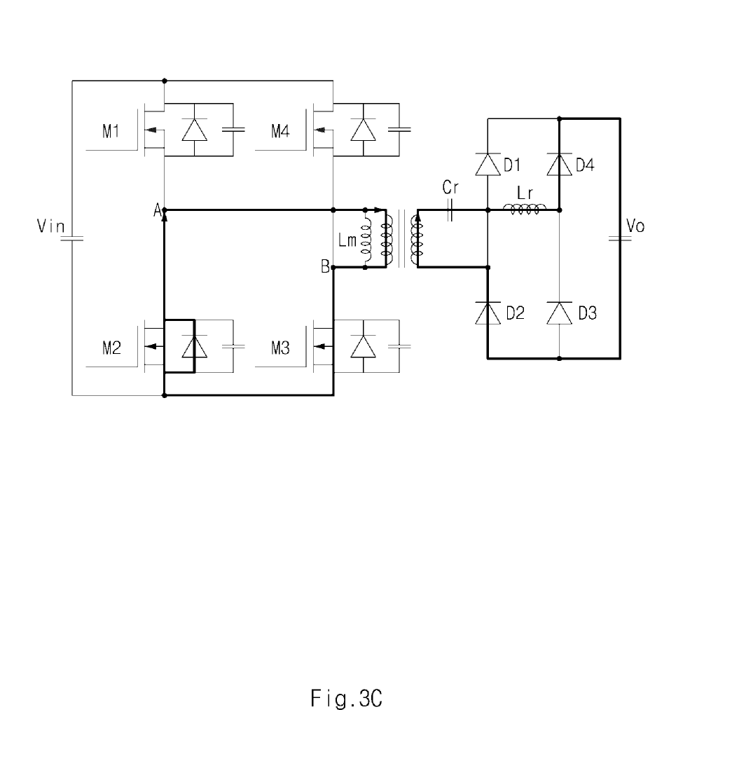

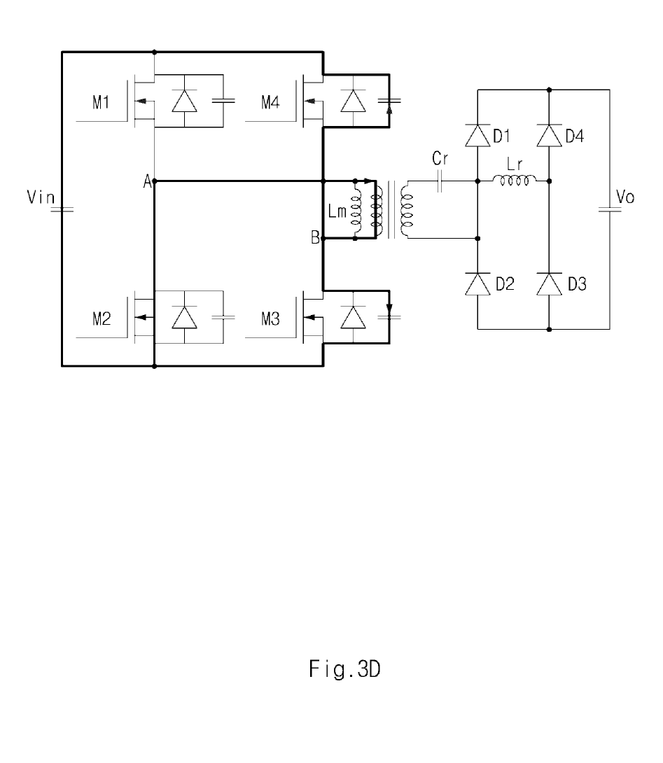

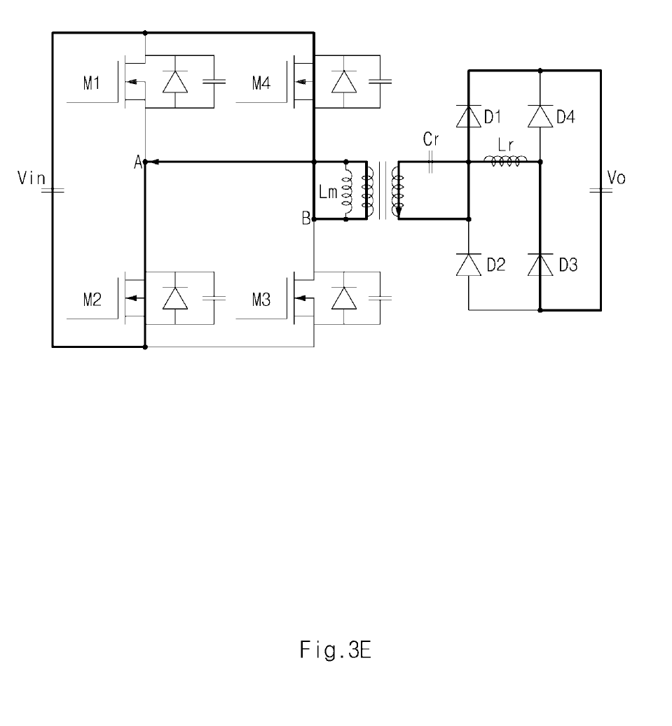

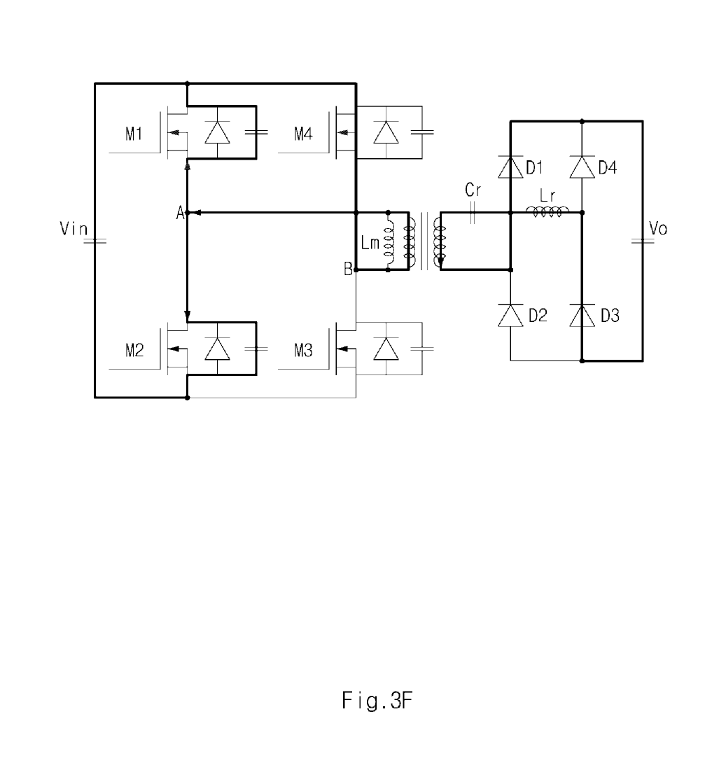

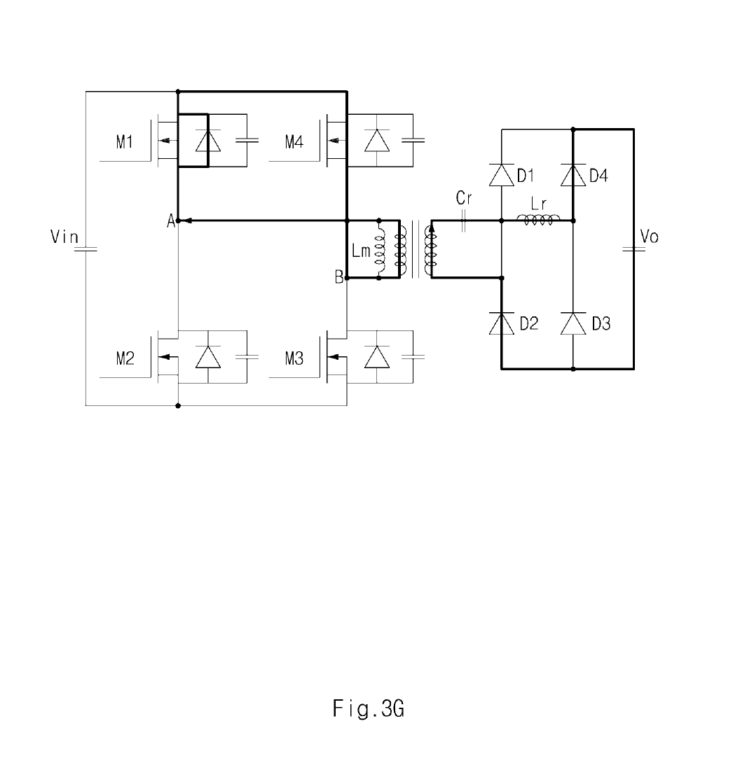

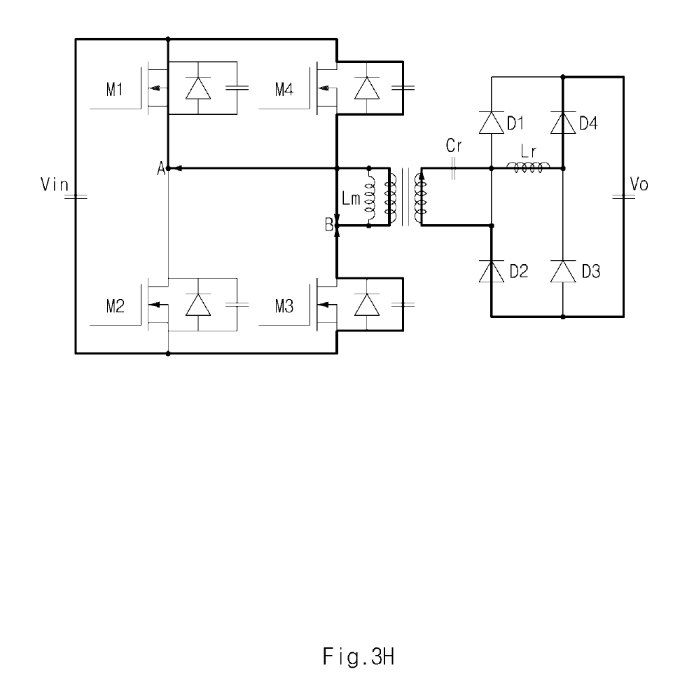

FIG. 2 is waveform diagram for each operation mode for describing an operation relationship of the LC resonant converter using a phase shift switching method according to embodiments of the present disclosure and FIGS. 3A to 3H are equivalent circuits depending on each of the operation modes of the LC resonant converter using a phase shift switching method according to embodiments of the present disclosure.

Prior to the description of the operation, the switches M1 and M2 of the leading leg circuit LE and the switches M3 and M4 of the lagging leg circuit LA are complementarily operated at a duty ratio of 50%. Further, D1, D2, D3, and D4 may represent a diode.

According to embodiments of the present disclosure, the switches M1 and M2 of the leading leg circuit LE implement the zero voltage switching using the magnetizing inductance Lm and the output current and the switches M3 and M4 of the lagging leg circuit LA implement the zero voltage switching using the magnetizing inductor Lm as in the following Equation.

$$Lagging Leg ; \frac{1}{2} {L}_{m} {I}_{P \_ ma x}^{2} + \frac{{I}_{0}}{N} > \frac{4}{3} {C}_{ds} {V}_{i n}^{2}$$

$$Lagging Leg ; \frac{1}{2} {L}_{m} {I}_{P \_ ma x}^{2} > \frac{4}{3} {C}_{ds} {V}_{i n}^{2}$$

$${I}_{P \_ ma x} = \frac{1}{2} \frac{{V}_{i n} {D}_{eff} T}{{L}_{m}} ( T = \frac{1}{{F}_{sw}} )$$

In the above Equation, Lₘ represents the magnetizing inductance, I_{P}_{_{—}}ₘₐₓ² represents a maximum current value, Iₒ represents an output current, C_{ds} represents an output capacitor (i.e., parasitic capacitance), Vᵢₙ² represents the input voltage, N is a turn ratio of the transformer, D_{eff} represents an effective duty, and T represents a turn on time of the switch.

Referring to FIG. 3A, like section t0 to t1 of FIG. 2 as mode 1, when the M1 and M3 are in a turn-on state, and the M2 and M4 are in a turn-off state at timing t0 to t1, the primary side current flows in a path from a input power supply Vin to the M1, the transformer, and the M3 and the secondary side current flows through the resonance capacitor Cr, the resonance inductor Lr, the D4, and the D2. In this configuration, a current flows in the resonance capacitor and the resonance inductor in a resonance form.

Referring to FIG. 3B, like section t1 to t2 illustrated by entering mode 2, when the M1 is turned off, the output capacitor of the M1 is charged and the output capacitor of the M2 starts to be discharged. The primary side current charges the output capacitor of the M1 using the magnetizing inductance Lm and the output current and the output capacitor of the M2 is discharged up to 0. That is, the M2 implements the zero voltage switching.

Referring to FIG. 3C, like section t2 to t3 illustrated by entering mode 3, when the M2 is turned on, free-wheeling is generated by a current at the magnetizing inductance and the induced output current and a load of the resonance current is transferred to the resonance capacitor Cr and the resonance inductor Lr.

Referring to FIG. 3D, like section t3 to t4 illustrated by entering mode 4, when the M3 is turned off, the output capacitor of the M3 is charged and the output capacitor of the M4 starts to be discharged. Only the magnetizing current is present at the primary side current and the output capacitor of the M3 is charged with the magnetizing current and the output capacitor of the M4 is discharged up to 0. That is, the M4 implements the zero voltage switching.

Referring to FIG. 3E, like section t4 to t5 illustrated by entering mode 5, when the M4 is turned on, a current flows in the M4 and the M2 and the primary side current flows in the input power supply Vin, the M4, and the transformer side and the secondary side current flows through the D1, an output power supply V0, the D3, the resonance inductor Lr, and the resonance capacitor Cr. In this configuration, a current flows in the resonance capacitor Lr and the resonance inductor Cr in a resonance form.

Referring to FIG. 3F, like section t5 to t6 illustrated by entering mode 6, when the M2 is turned off, the output capacitor of the M2 is charged and the output capacitor of the M1 starts to be discharged. Here, the output capacitor of the M2 is charged with the magnetizing inductance Lm and the output current and the output capacitor of the M1 is discharged up to 0 by the output current and the magnetizing current. That is, the M1 implements the zero voltage switching.

Referring to FIG. 3G, like section t6 to t7 illustrated by entering mode 7, when the M1 is turned on, the free-wheeling is generated by the magnetizing current of the primary side of the transformer and the induced output current. That is, the primary side current flows in the M4 and the primary side transformer and the secondary side current flows through the resonance capacitor Cr, the resonance inductor Lr, the D4, the output power supply V0, and the D2. In this configuration, a current flows in the resonance capacitor Cr and the resonance inductor Lr in a resonance form.

Referring to FIG. 3H, like section t7 to t8 illustrated by entering mode 8, when the M4 is turned off, the output capacitor of the M4 is charged and the output capacitor of the M3 starts to be discharged. That is, the output capacitor of the M4 is charged and the output capacitor of the M3 is discharged up to 0 by the magnetizing current. That is, the M3 implements the zero voltage switching.

Meanwhile, to verify the operation of the LC resonant converter circuit using a phase shift switching method according to embodiments of the present disclosure, a simulation may be performed by setting an input voltage to DC 270 V, an output to 48 V, 30 A 1.5 kW, and a switching frequency to 83 kHz.

As described above, according to embodiments of the present disclosure, it is possible to facilitate the zero voltage switching using the phase shift switching method and limit the current without using the output filter such as the output inductor by limiting the current by resonance using the resonance circuit whose secondary current side is provided with the resonance inductor and the resonance capacitor. Further, according to embodiments of the present disclosure, it is possible to facilitate the zero voltage switching by charging and discharging the parasitic capacitor using the phase shift switching method and the magnetizing inductance Lm. Further, according to embodiments of the present disclosure, it is possible to provide the zero voltage switching of the switches M1 and M2 using the output current induced from the secondary side of the transformer and the magnetizing inductance Lm by using the phase shift switching method and the zero voltage switching of the switches M3 and M4 by using the magnetizing inductance Lm. Further, according to embodiments of the present disclosure, it is possible to mount the element having the low voltage stress in the bridge rectifying circuit unit of the secondary side of the transformer by limiting the current by resonance without the output inductor.

As described above, although the present disclosure has been described with reference to embodiments and the accompanying drawings, it would be appreciated by those skilled in the art that the present disclosure is not limited thereto but various modifications and alterations might be made without departing from the scope defined in the following claims.

What is claimed is:

1. An LC resonant converter using a phase shift switching method, comprising:
a switching unit configured to receive a switching signal according to a phase shift control and to perform zero voltage switching (ZVS) in a leading leg circuit and a lagging leg circuit when a light load is present;
a transformer configured to output an output voltage of the switching unit as a predetermined level of voltage;
a resonance circuit unit provided at a secondary side of the transformer and configured to convert frequency characteristics of an alternating voltage transferred from the transformer; and
a bridge rectifying circuit unit configured to rectify the alternating voltage whose frequency characteristics are converted into a direct voltage.

2. The LC resonant converter according to claim 1, wherein the switching unit includes a leading leg circuit LE and a lagging leg circuit LA, each being configured of two switches, and the leading leg circuit LE and the lagging leg circuit LA have a duty ratio of 50% and are complementarily operated.

3. The LC resonant converter according to claim 2, wherein switches M1 and M2 of the leading leg circuit LE implement ZVS using magnetizing inductance Lm and an output current, and switches M3 and M4 of the lagging leg circuit LA implement ZVS using the magnetizing inductance Lm.

4. The LC resonant converter according to claim 2, wherein the leading leg circuit LE is configured of two switches M1 and M2, the lagging leg circuit LA is configured of two switches M3 and M4, each of the switches M1, M2, M3, and M4 is connected to anti-parallel diodes D1, D2, D3, and D4, respectively, and both ends of each anti-parallel diode are connected to output capacitors C1, C2, C3, and C4.

5. The LC resonant converter according to claim 4, wherein a primary side terminal of the transformer is connected between the two switches M1 and M2 of the leading leg circuit LE and between the two switches M3 and M4 of the lagging leg circuit LA.

6. The LC resonant converter according to claim 1, further comprising:
a magnetizing inductor connected between the two switches M1 and M2 and between the two switches M3 and M4.

7. The LC resonant converter according to claim 1, wherein the resonance circuit unit is connected to the bridge rectifying circuit unit.

8. The LC resonant converter according to claim 1, wherein the resonance circuit unit includes a resonance inductor Lr and a resonance capacitor Cr.

9. The LC resonant converter according to claim 1, wherein the resonance circuit unit includes a resonance inductor Lr and a resonance capacitor Cr which are connected to each other in series.
